(19) United States
(12) Patent Application Publication
(10) Pub. No.: US 2002/0165733 A1
(43) Pub. Date: Nov. 7, 2002

(54) Method and system for detecting variances in a tracking environment

(75) Inventors: Otto Pietari Pulkkinen, Helsinki (FI); Matti Hakkinen, Espoo (FI); Jukka-Pekka Sarkka, Espoo (FI); Jay Butterbrodt, North Andover, MA (US); Barbara Dumery, Cambridge, MA (US); Osmo Toikka, Helsinki (FI); Sami Sinkko, Mikkeli (FI)

Correspondence Address: BRUCE LONDA, NORRIS, MCLAUGHLIN & MARCUS, P.A., 220 EAST 42ND STREET, 30TH FLOOR, NEW YORK, NY, 10017, US

(73) Assignee: Instrumentarium Corporation, Helsinki (FI)

(21) Appl. No.: 10/116,350

(22) Filed: Apr. 4, 2002

Related U.S. Application Data
(60) Provisional application No. 60/281,651, filed on Apr. 5, 2001.

(51) Int. Cl. G06F 17/60

(52) U.S. Cl. 705/2

(57) ABSTRACT

Method and system for real time monitoring of activities within a health care tracking environment generates a substantially complete and accurate electronic patient care record, and makes information on evaluation of patient care, including identification of variances with the performance of patient care in accordance with a patient care event schedule, and patient care activities available in real time. The schedule is updated automatically, or based on human input, when the system deduces from the collected activity information that an event in the schedule has been performed or a change in patient care is necessary. When variances with the schedule of patient care are identified, caregivers are notified and patient schedules are accordingly modified based on the nature of the variance.

### FIELD OF THE INVENTION

The present invention relates generally to method and system for monitoring activities in a tracking environment and, more particularly, method and system for collecting activity data from within a tracking environment and processing the collected activity data to make information concerning monitored activities and status of an event schedule, the status of which is determined based on evaluation of the monitored activities in view of event schedule criteria, available in real time.

### BACKGROUND OF THE INVENTION

In a hospital, the ability to monitor activities relating to operational processes, such as scheduling patient flow through a diagnostic or treatment room, and the performance of events associated with patient medical treatment is important. By accurately and completely monitoring such activities, actions can be taken to ensure that appropriate health care steps are being performed properly and within the required time frame. Also, the movement of patients and caregivers, interaction between patients and caregivers and the health care steps taken with respect to a patient can be better managed and tracked.

If monitoring of activities must be performed manually, such as having a person type information into a terminal, the desired monitoring likely will not be achieved. A caregiver may not remember or input the actual time an event occurred when the caregiver enters the information manually. If a record of patient medical treatment activities is not accurate, selected medical treatment events likely will not be performed in proper sequence in relation with other medical treatment events, thereby precluding comparison and evaluation of medical treatment events in a rapidly changing care environment.

In acute care in a hospital, the activities performed by or associated with the medical treatment provided by a caregiver having clinical expertise and also a competency in operational and business functions, known as a clinical-operational hybrid caregiver, lend themselves to monitoring. Such hybrid caregivers include, for example, a clinical nurse specialist who has a masters preparation in nursing, is a clinical expert in the application of evidence-based practice and is responsible to senior hospital leadership to achieve quality, cost-effective patient outcome for a high volume patient population, which is typically defined by diagnoses such as stroke, congestive heart failure, respiratory failure, myocardial infarction and pneumonia. Other clinical-operational hybrid caregivers can include unit based case managers, discharge planners, hospitalists, intensivists and chief medical officers. It has been recognized that if the activities performed by or associated with the hybrid caregiver are monitored accurately and completely, the medical treatment related information collected can be used by the hybrid caregiver, as well as others, to establish performance measures and goals across clinical, financial, growth, and patient satisfaction perspectives.

In addition, by monitoring the medical treatment provided to a patient, the progression of medical treatment relating to a patient care schedule, which usually follows clinical practice care guidelines, can be better assessed. A patient care schedule essentially constitutes a schedule of events for a patient which is defined based on medical treatment guidelines developed by various professional practice, caregiver and hospital associations. The guidelines are usually based on the best evidence available on prevention, diagnosis, prognosis, therapy, avoidance of harm, e.g. negative side effects, and cost-effectiveness. One form of a patient schedule, known as a clinical care pathway, has been found to aid clinicians in decision-making by defining practice questions and identifying decision options and likely outcomes. The schedule of events for a care pathway can address, for example, specific health problems or diagnoses and require the collection of the following clinical information: patient name and arrival time; assessment of patient condition, such as by diagnosis, time and caregiver; tests to be performed and already completed and at what respective times; test results received and at what times; times and descriptions of planned and performed interventions by caregivers; re-assessment(s) of patient condition indexed by indicated diagnosis, time and caregiver; and time of discharge or transfer. It has been found that consideration of a caregiver's clinical judgment and a patient's values and expectations, while providing medical treatment for patients in accordance with a patient schedule, results in improved and cost effective care outcomes.

A further benefit of accurate and complete monitoring of activities related to medical treatment and operational processes is that the risk and cost of litigation relating to health care can be reduced. A permanent, irrefutable record of events that occurred is established, such that a question as to what events indeed occurred no longer exists and can be raised.

In addition, accurate and complete monitoring of medical treatment and operational process activities can help, and in some circumstances is necessary, to satisfy regulatory requirements. Standards presently in place and which are being developed require hospitals to initiate efforts to improve, for example, clinical performance. These data-driven performance measures are a factor in the accreditation process and provide for standardization of measurements between hospitals, thereby enabling benchmarking within and between hospitals. The clinical measures that need to be monitored for regulatory purposes include those that (i) are designed to evaluate the processes or outcomes of care associated with the delivery of clinical services; (ii) allow for intra- and inter-organizational comparisons to be used to continuously improve patient health outcomes; (iii) allow for focus on the appropriateness of clinical decision making and implementation of these decisions; and (iv) address important functions of patient health care, for example, medication use, infection control, patient assessment, etc.

Also, accurate and complete monitoring of activities associated with the sequence of medical treatment and operational process events that occur in relation to patient health care can make allocation of resources, personnel and equipment more efficient.

Therefore, a strong desire and need exists to incorporate and integrate one or more of the following features or functions into a comprehensive monitoring system: collecting accurate, complete and irrefutable data representative of monitored activities relating to medical treatment and operational processes; determining progress on a patient care schedule; alerting a caregiver when the progress of medical treatment for a patient is in not in accordance, in other words at variance, with a patient care schedule; meeting regulatory requirements; reducing the risk of litigation; establishing a real time accessible record of events that have occurred, including caregiver and patient locations indexed by time; tracking and modeling resource utilization; tracking the performance of caregivers; and reducing documentation burden upon caregivers.

Although systems which rely on logistics to collect and process activity data exist in industries such as warehousing and distribution, a comprehensive system for monitoring human tasks and interaction with monitored patients in a tracking environment, and which specifically addresses the needs of an acute health care facility, is not available.

Moreover, current techniques for monitoring activities in a health care facility are not completely satisfactory because they do not permit accurate, real time and substantially complete collection of the health care information from which real time assessments on the progress of health care for patients can be performed. Also, current techniques do not provide for real time performance or identification of medical treatment activities, where there has been a real time identification of a variance with a patient schedule based on real time monitoring of medical treatment activities. U.S. Pat. No. 5,991,730, incorporated by reference herein, for example, discloses a patient tracking technique which tracks patient location by detecting movement of the patient medical file among receptacles located at a medical facility. The information collected and relied upon to make the location determination constitutes low level information which does not permit a real time care assessment and real time care activities based on that assessment. The information ordinarily cannot be utilized to generate timely alerts concerning needed medical treatment activities, because the assessment of events in accordance with a patient care schedule is not performed in real time.

Similarly, while there are many known techniques that provide for the management and documentation of information related to patient schedules, such techniques do not include the feature of real time assessment of the collected information in connection with medical treatment guidelines that would permit improvements in patient health care which include causing or suggesting the performance of activities in real time. For example, U.S. Pat. No. 6,230,142, incorporated by reference herein, describes a system that enables a caregiver to store and analyze clinical pathway data, to make historical comparisons, such as identifying trends in the data, and to provide after-the-fact health care outcome tracking and documentation capabilities. In addition, U.S. Pat. Nos. 5,953,704 and 5,583,758, incorporated by reference herein, disclose systems which caregivers utilize offline to perform comparisons between proposed and actual care paths and their outcomes. Also, U.S. Pat. No. 5,740,800, incorporated by reference herein, describes an information system for clinical pathway management which, based on caregiver input, assists in the selection of correct order sets for care patients. U.S. Pat. No. 5,946,659, incorporated by reference herein, describes a system enabling simultaneous entries for pathway variances from several users, and U.S. Pat. No. 5,785,530, incorporated by reference herein, discloses a system used for three-dimensional visualization of clinical pathways. The above-mentioned patents, while providing for processing of collected clinical care information, do not include the feature of using the collected information to assess the progress of medical treatment in relation to patient schedule criteria in real time and to cause or request the performance of specific medical treatment actions, in real time, based on the assessment.

U.S. Pat. No. 5,960,085 describes a system that permits a patient or a caregiver to access confidential patient information upon detection of an electronic identification card by a computer system. This system, while enhancing secure data access, similarly does not contemplate or describe the use of the collected information to assess the progress of health care in real time and provide for real time medical treatment activities based on the assessments.

A health care facility management system is currently available from Versus Technology, Inc. The system employs IR/RF technology to provide real-time, continuous, location-specific information about people and equipment as they move through the facility. Each person or piece of equipment wears a transmitting badge with a unique ID. Data is collected passively, to provide information on room status, equipment being utilized for a given patient, and presence and frequency of interaction between patient and staff. Patient movement is facilitated by directing patients to available testing areas. Instant knowledge of the onset and duration of a procedure allows the facility to plan ahead. The amount of time spent between a patient and a caregiver is recorded, as the amount of time for a particular procedure. The data is used for reports, particularly those for compliance with JCAHO standards. Some of the reports available include a ‘Tracking Log’, which details the movement of an individual or piece of equipment throughout the facility, including identifying each room entered, arrival and departure time and total time spent in each room. A ‘Time Together’ report shows how much time different people or equipment have spent together in a particular room for any given time period. This data may be used for billing or audit reports. Although the mechanism of the time together report is not set out, it appears that it searches for same-room presence during a common time frame for two people/equipment, rather than recording a direct proximity signal between the two. <http://www.versustech.com>.

Linked interaction between two objects, for example a person and equipment within a health care facility is taught by Axcess Inc. Using RFID tagging technology, a system provides for tracking and location assets throughout a facility on-demand, determining equipment status and inventory, locating personnel, protecting assets from unauthorized removal from a ward or facility. The latter is achieved by providing tags for each piece of equipment. As the equipment approaches an exit door or other restricted area, the tag is identified and appropriate alarm signal can be sent. Personnel tags can be linked via software to particular assets or a certain type of equipment, with a defined relationship permitting the free movement of the equipment only when it is accompanied by an authorized person. The system is programmed to override the alarm signal when the identified location of a piece of equipment and an authorized person coincide. <http://www.axsi.com/whitepapers/wp health.shtml>.

U.S. Pat. No. 6,154,139 relates to a method and system for locating subjects within a tracking environment, such as a health care facility. Personnel (such as patients and caregivers) are provided with transmitting tags, which transmit both an IR (line-of-sight) identifying signal and a RF (non-line-of-sight) identifying signal. The IR signal is effective in accurately determining location to a specific degree. However, because it requires line-of-sight, it can not be used to locate personnel in sensitive areas where IR receivers are not placed. In this case, a RF signal may reach a RF receiver within a certain distance, even through walls. Therefore, if a patient presses a distress call from the bathroom, the RF receiver transmits this signal to the central processor, which can locate the patient by way of the last IR signal received (e.g. hallway outside of bathroom).

U.S. Pat. No. 6,211,790 relates to an infant-parent matching system, based on a dual-mode infrared/radio frequency (IR/RF) transmitter secured within a wristband worn by the mother and within an ankle and/or wristband worn by the infant. In a matching mode of operation, IR signals are received by infrared receivers located within the various rooms of the hospital to precisely and automatically determine by proximity that mother and infant are correctly united. In a presence detecting mode, RF signals from the infant's badge are detected by RF receivers located throughout the maternity ward of the hospital or throughout the hospital generally. In a security mode, RF receivers located proximate exits of either of the maternity ward and/or the hospital detect RF signals from the ankle and provide a signal to generate an alarm.

The above patents teach generally a system for tracking movement and location of personnel, and for determining, the co-presence of two people based on the fact that they were deemed to be located in the same location for an overlapping period. This information is used for billing and for back-checking. However, these systems are only of limited use, since they do not provide for real-time updating of patient schedule status, or variance from an expected event, such as would be based on a patient schedule. Furthermore, the patents teach that alarm signals may be generated based on improper linking, or alternatively a separation, of two people or a person and an object. While these alarm systems are useful for security purposes, they are not geared toward real-time patient care issues, which is interactive and dynamic.

### SUMMARY OF THE INVENTION

In accordance with the present invention, method and system for monitoring activities within a tracking environment collects activity data, preferably in real time, and automatically processes the collected data in real time to assess and update the status of performance of a schedule of events, which includes an evaluation of whether events of the schedule were performed or not based on predetermined schedule criteria, and to make information concerning the schedule status, which includes identification of detected variances from the event schedule, and the monitored activities available for real time and archival retrieval. In a preferred embodiment, the tracking environment is a health care facility; the monitored activities include medical treatment and operational process events, such as physiological measurements, patient and caregiver locations, patient, caregiver and medical equipment proximity information, and evidence of interventions or actions between a caregiver and a particular patient; and the schedule is a patient care event schedule, such as a clinical care pathway, including medical treatment and operational process events which a caregiver selects for the patient and includes predetermined criteria which are utilized to identify variances from the scheduled events.

In a preferred embodiment, the system includes a controller coupled by a wireless, wired or combination wired and wireless network to sensors, identification badges, physiological output data monitoring equipment and portable or fixed interfaces, each of which is located within a tracking environment. Each of the badges is either an active device, such as an infrared (“IR”) or radio frequency (“RF”) transceiver which automatically transmits encoded identification data signals, a passive device, such as an RF transponder or an IR readable barcode which when interrogated respectively by an RF or IR source reflects encoded identification data signals, or a combination active and passive device. The badges can be located or carried directly on or adjacent to patients, caregivers and fixed or portable diagnostic or medication dispensing equipment. The output monitoring equipment is coupled to medical diagnostic or treatment equipment, or to existing data networks to which the medical equipment may already be coupled. The monitoring equipment further includes a transmitter that transmits to the controller time encoded activity data signals representative of physiological conditions, such as vital signs, that the medical or diagnostic equipment measures, as well as the identities of the caregiver operating the medical equipment and the patient being monitored. The interfaces preferably include a graphical display, manual or voice data input capabilities and a transceiver apparatus which receives control signals from and transmits energy signals including activity data and other data, such as instructions for modifying a patient care schedule, manually input by a caregiver to the controller, preferably over a hardwired electrical or optical data signal communication link. The sensors are energy signal transceivers which detect IR and/or RF encoded identification data signals and transmit to the controller, also preferably over the hardwired link, digital activity data signals representative of the detected identification data signals. Preferably, the sensors are positioned at strategic, predetermined locations throughout a tracking environment to ensure complete and accurate monitoring. In a preferred embodiment, the collected activity data is representative of IR or RF energy signal interaction between a sensor and the badge of a patient or caregiver, or between the badge of a patient and the badge of a caregiver.

The controller is a microprocessor which executes predetermined or user modifiable software programs, stored in its internal memory, to collect activity data transmitted thereto from within the tracking environment and to process and store the activity data. The controller preferably processes the collected data in accordance with a patient care event schedule to decide whether an event in the schedule was satisfied and accordingly updates the schedule, preferably after obtaining confirmation from a caregiver. In a preferred embodiment, a caregiver, such as a physician, interacts with the controller at the interface to select the type and extent of monitoring of activities performed for a specific patient. The controller determines and stores in its memory a time indexed record of the locations of patients and caregivers, patient-caregiver, patient-equipment and caregiver-equipment proximity information, and care events performed or occurring in connection with the patient, based on the collected activity data. Further, the controller makes information concerning the monitored activities and the status of the event schedule for the patient, which is based on assessment of the collected activity data, available in real time.

In a preferred embodiment, the controller decides whether an event in the schedule has been performed by determining from the collected information whether a caregiver was in proximity to a patient for a predetermined time interval.

In an alternative preferred embodiment, the schedule includes time duration and interaction criteria to which the controller compares the collected information to decide whether an event in the schedule has been performed. The controller deduces that an event in the schedule is satisfied if the proximity information for the caregiver indicates that the caregiver was detected as being in the same zone as the patient for a predetermined interval, that the physiological measurement data associated with the patient also was collected by a particular caregiver during the time interval and that the measurement data is representative of vital signs within predetermined acceptable levels. It should be understood that ‘zone’ can be defined appropriately as a particular room, or even an area within the room, such as a small area around the patient's bed.

In a preferred embodiment, the controller continuously assesses the schedule criteria to determine if the collected information evidences a variance between the care being provided to the patient and the requirements of the care event schedule. If a variance is identified, the controller causes the interface to generate an audible or visual alarm to cause a caregiver to perform additional care actions that would remove or compensate for the variance. In an alternative embodiment, the controller modifies the patient schedule, with or without requiring caregiver confirmation, when a predetermined variance is identified.

### BRIEF DESCRIPTION OF THE DRAWINGS

Other objects and advantages of the present invention will be apparent from the following detailed description of the presently preferred embodiments, which description should be considered in conjunction with the accompanying drawings in which:

FIG. 1 is a block diagram of a system for collecting activity data from within a tracking environment and processing the collected activity data in accordance with one embodiment of the invention;

FIG. 2 is a block diagram of the controller of the system of FIG. 1 in accordance with one embodiment of the invention; and

FIG. 3 is a flowchart of an implementation of the processing of activity data collected by the system of FIG. 1 in relation to a patient schedule, according to one embodiment of the invention.

### DETAILED DESCRIPTION OF PREFERRED EMBODIMENTS

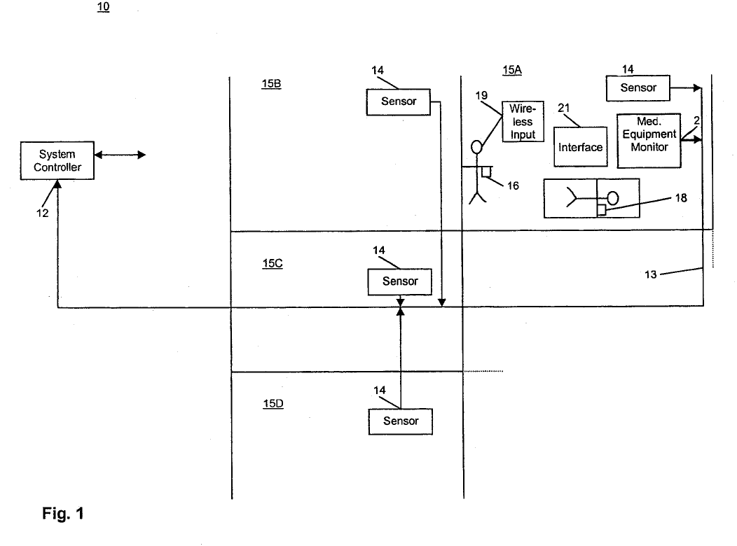

FIG. 1 shows in block diagram form an embodiment of a system 10 for monitoring activities in a health care facility tracking environment in accordance with a preferred embodiment of the present invention. The system 10 is an automated, universal and electronic monitoring platform for a health care facility, which is a combination wired and wireless network and utilizes IR and RF based locating and positioning technologies and technical knowledge concerning physiologic measurements, to provide, preferably with real time data acquisition and information retrieval capability, evaluative information on the real time progress and performance of patient care and a record of caregiver, patient and medical equipment locations and medical treatment and operational process events performed or that occurred within the tracking environment. Although the present invention is described in detail below in connection with monitoring activities within a health care facility, it is to be understood that activities in other environments, such as in an industrial or commercial environment, can be monitored in accordance with the present invention to make information available in real time concerning the activities and performance of activities associated with an event schedule specific to those environments.

Referring to FIG. 1, the system 10 includes a controller 12 coupled by wired or wireless data communication links to sensors 14, a wireless, portable caregiver identification badge 16, a wireless, portable patient identification badge 18, a wireless, portable voice activity data transmitter 19, medical diagnostic monitoring equipment 20 and an interface 21. The components of the system 10, exclusive of or including the controller 12, are within a tracking environment to provide that the system 10 collects activity data, preferably passively, automatically and in real time, representative of medical treatment and operational process events occurring or performed within the tracking environment.

The badges 16 and 18 are active IR transceiver assemblies that automatically emit digitally encoded IR identification (“ID”) data signals of predetermined amplitude which identify the source of the energy signal transmission. Alternatively, the badges 16 and 18 are RF or combination RF/IR transceiver assemblies which automatically emit IR or IR and RF ID data signals, respectively. See U.S. Pat. No. 6,154,139 and WO 01/33748, incorporated by reference herein. In a further embodiment, a badge includes a IR scannable barcode or an RF transponder which when interrogated respectively by an IR or RF source, such as another badge or one of the sensors 14, reflects ID data signals preferably toward the interrogating source.

The transmitter 19 is a conventional voice activated voice recognition device which detects and processes voice energy signals for generating corresponding voice data. The transmitter 19 further includes an RF or IR transmitter assembly for generating and transmitting digitally encoded RF or IR voice data signals based on the voice data.

Each of the sensors 14 includes a transceiver for transmitting RF or IR interrogating signals and receiving IR or RF identification data signals and optionally voice data signals. Further, each sensor 14 includes a digital signal processing assembly and electrical or optical signal generating components for generating and transmitting digitally encoded activity data signals to the controller 12, based on the detected signals, over an electrical or optical fiber data communication link, or combination electrical and optical link, 13. The activity data signals are encoded to indicate time of their transmission from the sensor 14 and the detected location and identity of the caregiver, patient or the voice data transmitter 19 which is the source of the activity data. The sensors 14 are positioned at strategic locations or zones 15A, 15B, 15C, 15D, etc., within the hospital tracking environment, such as passageways, entry and/or exit points within a patient room, treatment rooms, single function rooms, patient beds, etc., to permit accurate and complete real time tracking of the locations and movement of patients and caregivers and medical and diagnostic equipment.

In a preferred embodiment, the sensor 14 transmits RF or IR energy signals to interrogate a passive badge and processes the reflected interrogating energy signals, which constitute encoded identification data signals, to generate activity data representative of the location and identity of the badge interrogated. In still a further embodiment, the reflected interrogating signal includes data encoding which identifies the badge that is the source of the interrogating signal, and the sensor includes such source identification data in the activity data transmitted to the controller.

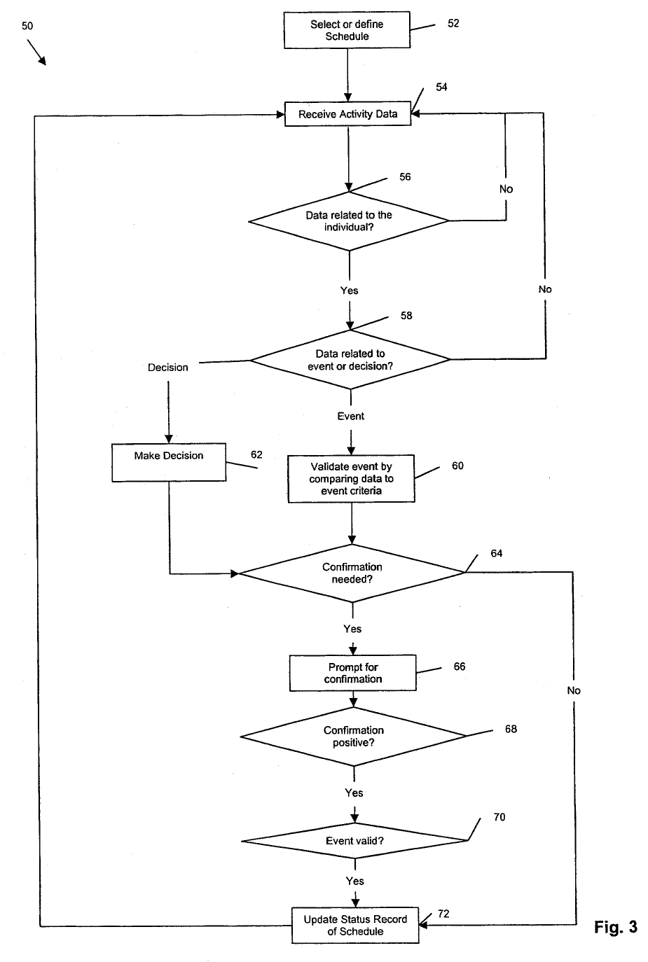

In a further preferred embodiment described in detail below in connection with FIG. 3 and the accompany text, the system 10 uses caregiver-patient proximity information obtained by energy signal interaction among the sensors and badges in accordance with known, conventional techniques to assess whether certain events specific to patient care have or have not been performed. For example, in a system available from Versus Technologies, Inc., a caregiver-patient proximity is determined by comparing location and time data to find overlap, thus indicating proximity for the duration of the overlap.

The medical monitoring equipment 20 includes a physiological data collection assembly, such as a conventional digital signal processor and a memory. The assembly is coupled to the data output port of medical equipment (not shown), or an existing hard wired data network to which the data port of the medical equipment is connected. The assembly detects available identification data, which identifies the patient, caregiver and equipment, and physiological output data, such as digital data representative of blood oxygen level provided at an output port of a pulse oximeter. The assembly then converts the detected data to time encoded digital activity data signals which include the physiological data and identify the caregiver, the medical equipment and the patient associated with the physiological data. The equipment 20 further includes a transmitter assembly which transmits the digital activity data signals to the controller 12, in substantially real time, over the link 13 which extends between the equipment 20 and the controller 12.

The interface 21 preferably is a microprocessor based graphical display, such as a flat screen monitor, including an input device, such as a keypad or a keyboard. The interface 21 includes a RF transceiver assembly which transmits to the controller 12 digitally encoded RF activity data signals, based on data that a caregiver enters concerning a care event, for example, data indicating that the caregiver administered medication to the patient at a particular time. The interface 21 furthermore receives RF control signals transmitted from the controller 12 and instructing the interface 21 to, for example, display text data or cause an attached or an integrated annunciator or light source to sound or illuminate, respectively. In a preferred embodiment, the interface 21 transmits control signals, based on caregiver input, to modify a care event schedule that the system 10 performs to attend to the care of a patient. In a preferred embodiment, the interface 21 is a PDA or keypad-based data entry device including a IR barcode scanner, RFID reader, or a smart card reader. In an alternative preferred embodiment, the interface 21 is coupled to a wired LAN to which all components of the system 10, except for caregiver and patient badges, are coupled.

The system may also allow for monitoring equipment 20 to be coupled to other information systems in a hospital, such as laboratory information system in which data has been entered, for example, manually or through a bar code, using known commercial interface technologies such as XML and HL7. The equipment 20 should be programmed to monitor selected data transmitted by such systems and to transmit copies of such data to the controller 12.

In a preferred embodiment, the system 10 is a completely wireless network encompassing an entire hospital facility and monitors physiologic measurements of a patient continuously, regardless of location, and also the locations of the patients and caregivers from ID data signals generated by RF or IF energy signal interaction between a sensor and a badge or between a patient badge and a caregiver badge.

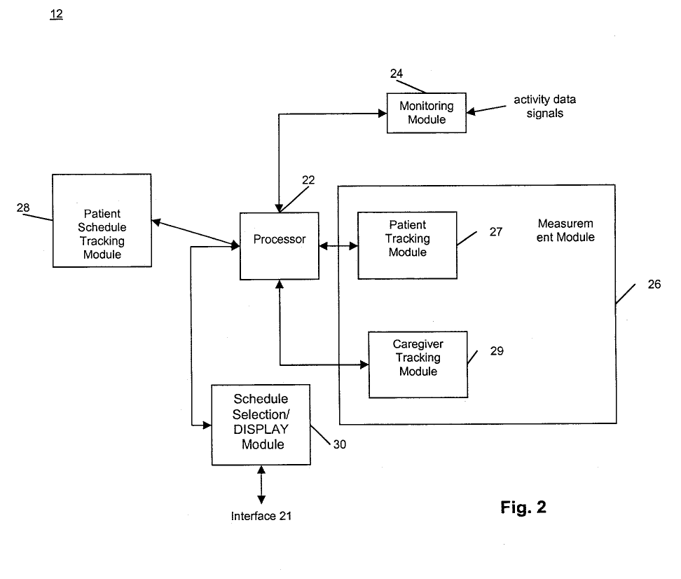

Referring to FIG. 2, the controller 12 includes modules that execute software programs to implement the features of monitoring activities in a health care facility tracking environment in accordance with the present invention. It is to be understood that each of the modules within the controller 12 which is described below as performing data processing operations is a software module or, alternatively, a hardware module or a combined hardware/software module. In addition, each of the modules of the controller 12 suitably contains a memory storage area, such as RAM, for storage of data and instructions for performing processing operations in accordance with the present invention. Alternatively, instructions for performing processing operations can be stored in hardware in one or more of the modules in the controller 12.

In accordance with a preferred embodiment, the system 10 collects activity data, preferably passively, automatically and in real time, relating to patient and caregiver locations and proximity and events and measurements performed or occurring which are associated with a patient care event schedule including clinical care pathway events, and generates from the collected activity data a substantially complete and continuously updated record of patient care that is accessible in real time.

Referring to FIG. 2, the controller 12 includes a processor module 22 coupled to a monitoring module 24, a measurement module 26, a patient schedule tracking module 28 and a schedule selection/display module 30.

The monitoring module 24 includes a receiver assembly for receiving digitally encoded activity data signals which are carried on electrical or optical signals conveyed over suitable wired data communication links extending between the controller 12 and the source of the signals, such as the monitoring equipment 20 and the sensors 14. Further, the receiver assembly can receive RF and IR activity data signals transmitted from the tracking environment. The module 24 extracts the activity data from the carrier signals and then forwards the activity data to the processor 22. The processor 22, based on the source and location identification information encoded with the activity data, selectively routes the activity data associated with patient or caregiver badges respectively to a patient tracking module 27 or a caregiver tracking module 29 in the measurement module 26. The modules 27 and 29 respectively process the received activity data to create a time indexed record of patient and caregiver location within the hospital tracking environment and store such indexed records in their respective memories. In a preferred embodiment, the modules 27 or 29 determine the locations of a patient and caregiver based on the identities of the sensors that are the sources of the activity data signal transmissions, or by using triangulation or other multilateration identification techniques.

In addition, the processor 22 recognizes activity data whose sources are the equipment 20 and the transmitter 19 and routes such activity data to the measurement module 26. The module 26 processes and then stores in its memory such activity data in the form of a record indexed by source and time and cross-referenced by patient and caregiver, as suitable and available. As part of the processing, the module 26 converts the activity data representative of voice data into a data form suitable for storage, retrieval and processing by the other modules of the controller 12.

Referring again to FIG. 2, the module 30 includes a transceiver assembly, preferably having RF, optical or electrical signal reception and transmission capability, which facilitates exchange of data between the controller 12 and the interface 21. For example, the module 30 can route control data signals to the interface 21 which cause the interface 21 to sound an alarm or display a prompt on its screen requesting additional information from a caregiver. Also, the module 30 can receive from the interface 21 activity data and instructions concerning details of the schedule to be applied to a particular patient.

The module 28 includes in its memory predetermined software programs which constitute patient event schedules. A caregiver, such as a physician, at the interface 21 selects or modifies an existing schedule for a particular patient. The module 28 performs a selected program to effectuate, in accordance with the selected patient schedule, the continuous evaluation of whether events scheduled have been performed, need to be performed, etc. The module 28 executes the programs by having the processor 22 retrieve time indexed location records of patients and caregivers, patient-caregiver proximity and other patient specific activity data from the modules 26, 27 and 29, as suitable.

Referring to FIG. 3, the system 10 in a preferred embodiment implements steps of an exemplary process 50 that facilitates real time evaluation of a patient event schedule in a hospital environment, performance of care activities in real time based on the real time evaluation of the schedule and documentation of activities relevant to the schedule and hospital operational processes in general. The system 10, in substantially real time, identifies variances from patient schedules and generates suitable alarms to correct and notify caregivers of the variances in substantially real time. Referring to FIGS. 2 and 3, the module 28 retrieves, via the processor 22, time indexed records concerning patient and associated caregiver location and patient-caregiver proximity from the respective modules 27 and 29 and physiological measurement information from the module 26. These records are derived from and representative of the ID data signals generated by or at the badges 16 and 18, the voice data signals transmitted by the transmitter 19 and the activity data signals transmitted by the equipment 20, as suitable. The module 28 continuously assesses the recorded activity data in comparison to events included in the selected patient schedule. The module 28, based on the event schedule and associated event criteria, evaluates the recorded data and in real time interprets the activity data in the context of the events of the schedule to identify variances with the schedule. The module 30 identifies the variances to caregivers at the interface 21. The module 28 updates the status of performance of, or modifies, the schedule based on the evaluations that are made, including the variances identified. In a preferred embodiment, the module modifies the schedule when a variance is identified only after a caregiver at an interface confirms that the schedule modification is proper.

The process 50 is illustrated below in connection with a patient schedule that is assigned to a patient arriving at the emergency dock of a hospital and complaining of chest pain. After the patient is admitted, an admitting physician diagnoses the patient to determine what care pathway schedule the patient should follow. Referring to FIG. 3, in step 52, the physician interacts with the controller 12, at the interface 21, to select or define a schedule for a patient. The selected, patient specific schedule is then identified, and if required stored, in the memory of the module 28. The schedule includes predetermined or user modifiable events and validation and decision criteria applicable to evaluation of progress and completion of events in the schedule. The schedule also can be modified at any time by a caregiver at the interface 21, or by the module 28 itself without human intervention as described below.

In a preferred embodiment, the contents of a schedule include the events, and descriptions thereof, that need to occur or steps that need to be taken for the patient or a group of patients. For example, the schedule can include a set of partially of ordered events possibly including timing requirements and predetermined criteria for validating each event. Some of the events may involve decisions based on the continuously incoming activity data, such as physiological measurement data, and therefore the schedule further can include decision criteria. The status of the performance of a schedule is based on the events that have taken place, the decisions made by the system 10 in conjunction with the activity data relevant to the decisions and possibly some other relevant data.

In step 54, the monitoring module 24 continuously receives activity data signals from the tracking environment, extracts the activity data and then forwards the extracted activity data to the processor 22. For example, when the physician with the badge 16 moves the admitted patient with the badge 18 to the diagnosis room designated zone 15A, the sensor 14 in the zone 15A detects the RF identification data signals that the badges 16 and 18 are continuously or substantially continuously transmitting. The sensor 14, in turn, generates and transmits activity data signals indicating that the physician and patient assigned to the badges 16 and 18 respectively were detected as being in proximity in the zone 15A at certain times. The proximity information continues to be generated and transmitted to the module 24 while the physician performs an EKG that is monitored by the monitor 20. The monitor 20 transmits activity data signals, preferably including physician and patient identification information as well as EKG vital sign information, having the same time stamp information as the proximity information that the sensor 14 in the zone 15A transmits concerning the physician and patient being detected as present simultaneously in the zone 15A. When the physician leaves the room 15A and walks more than ten feet away from the sensor 14 while the patient remains in the room 15A, the sensor 14 in the room 15A no longer detects the RF signals being transmitted by the badge 18 and, therefore, no longer transmits activity data representative of proximity information.

As part of step 54, the processor 22 suitably routes the activity data to the measurement module 26, and its modules 27 and 29. The modules 26, 27 and 29, in turn, process the activity data to generate records indexed by time, patient, caregiver, patient and caregiver locations and proximity, as applicable, and store such indexed data in memory.

In a preferred embodiment where the sensors 12 passively and automatically collect information concerning the locations of patients and caregivers and care events performed or associated with patients, an irrefutable, electronic record of patient care is created. The record is not open to question because human judgment or action, such as manual marking a time entry on a clipboard or entering of a time in a computer, is absent. This form of monitoring of activities improves utilization of resources and also assists in the process of credentialing a health care facility.

Other modules in the controller 12, such as the modules 28 or 30, advantageously can access the data records stored in the module 26, which includes the modules 27 and 29, in real time.

In a preferred embodiment, the processor 22 can retrieve and process the records stored in the module 26 offline, in other words not in real time, to generate prepared reports relating to, for example, patient charting, order entry, outcome management, quality assessment, utilization review and patient admission details, such as patient tracking, bed management and scheduling. For example, the processor 22 can use the activity data to generate a prompt for an automated billing system which states the following: “Dr. Smith, pulmonologist, was in proximity to Patient Jones, respiratory failure, for 37 minutes today starting at 09:32. Was this a billable pulmonary consult?”

In step 56, the processor 22 continuously retrieves and evaluates the records stored in the module 26 to determine whether new activity data related to the individual patient has been recorded. If yes, the processor 22 forwards the identified new data records to the module 28.

In a preferred embodiment, the processor 22 effectively filters the collected records concerning a particular patient by forwarding to the module 28 only new data records concerning caregivers who were detected as being in proximity with the patient and also designated as potential caregivers for the patient in accordance with the patient event schedule for the patient. Thus, the module 28 evaluates and processes only that activity data received from the tracking environment which are relevant to the predetermined schedule selected for the individual patient. The processor 22 does not forward to the module 28 activity data received at the module 24 and stored in the module 26 which is not relevant to the particular patient and patient schedule, such as the casual presence of a pediatric caregiver in the vicinity of a patient scheduled for open heart surgery during transfer of the patient to an operating room.

In step 58, the module 28 determines whether the recorded activity data that the processor 22 forwarded relates to an event or a decision in the schedule. For example, an event can include the taking of vital signs, which the triage nurse records at an interface 21; the patient leaving a waiting area, which the system 10 passively detects and records; a nurse seeing the patient, which the nurse records by pushing an alarm button on the patient badge 18; a physician seeing the patient, which is recorded when the sensor 14 detects the physician as present in the patient's room 15A and when the physician confirms the meeting and the diagnosis at the interface 21 after being prompted; drawing of the patient's blood sample in a laboratory, which is recorded based on patient location detection and the laboratory nurse scanning the patient badge 16 with an RF reader coupled to the interface 21; and a nurse dispensing medication prescribed by the physician to the patient, which the nurse records at the interface 21 by scanning the badge 16 and a badge including a barcode attached to a medicine vial.

If the module 28 determines that the recorded data corresponds to an event set forth in the schedule, the module 28 in step 60 validates the determination by comparing the activity data associated with the event with criteria for confirming that the event indeed occurred. In a preferred embodiment, the system 10 validates an event using caregiver-patient proximity information stored in the module 29. For example, a specific event can be validated if the proximity information indicated that a selected caregiver was detected as being within a predetermined distance from the patient for whom the caregiver is designated to provide care at specified times.

The proximity information used in step 60, in a preferred embodiment, is based on activity data obtained using RF and/or IF location technologies that identify the precise locations of the patient and caregiver. For example, in step 58, module 28 may have determined that received information, namely patient proximity with an EKG machine and a physician, is related to an EKG event. This data is compared to the schedule event criteria (requiring, for example, that the EKG should be taken before 4 pm. the given day) and thus validated. However, since the co-location of a patient, physician and the EKG machine sometimes happen accidentally, the schedule states that a confirmation from the physician is needed. Therefore, a message is displayed in her/his PDA asking for confirmation. After the confirmation the event is finally validated and the patient status record updated.

Alternatively, in step 58 the module 28 may have determined the presence of the scheduled event of measurement of the patient's EKG based on the EKG vital sign information, which is indexed with the patient's name and was transmitted by the monitoring equipment 20. The schedule requires that proximity information be used to validate that the EKG was performed. Therefore, in step 60, the module 28 retrieves and evaluates the proximity data for the patient to confirm that the EKG measurement event was performed for the patient. For example, the module 28 evaluates the proximity information to determine whether the EKG vital sign information was transmitted at substantially the same time that the physician and patient were in proximity in the room from which the EKG vital sign information was transmitted.

In an alternative embodiment, the module 28, from the patient location records stored in the module 26, validates the EKG event for the patient by ascertaining whether the patient had been to a particular diagnostic room in the hospital, stayed there for a believable length of time and then had left. The patient location record is derived from, for example, activity data that a sensor positioned at the entrance to the diagnostic room generates by scanning a scannable IR barcode identifier badge attached to the patient's wrist or to a movable gurney. The module 28 then processes this information and concludes, without human intervention, or at least subsequently prompts for human confirmation at the interface 21, that a procedure associated with the room, namely, the EKG measurement, which was indicated as the next step on the care schedule that had not yet been performed, had been completed.

If the module 28 in step 58 determines that the recorded data relates to a decision, the module 28 in step 62 assesses the recorded data to decide, for example, whether and how the schedule should be updated or if an alarm should be generated at the interface 21. For example, the decision criteria relating to an event in the schedule may require the module 28 to continuously evaluate information concerning several vital signs of the patient, such as blood pressure, blood oxygen level and heart rate. In the event the vital signs fall within undesirable ranges established by the schedule criteria, the module 28 would identify the presence of a variance with the scheduled events and, preferably, modify the course of care according to the schedule to require immediate care by caregivers.

More routinely, the system and schedule is updated by caregiver interaction. For example, a physician, using the central patient monitoring system, decides on the correct continuation of the care schedule for a patient based on the values she sees in the hospital's central monitoring system. She enters the selection into the system, e.g. from her PDA interface. Since the data itself is input directly by a physician, the system knows that no further confirmation is required, and the correct continuation for the schedule is selected and subsequently tracked.

The schedule as modified can include additional events that need to be completed in an emergent care situation, such as an electric shock in the event the EKG vital signs indicate that the patient's heartbeat had certain irregularities. Consequently, the module 28 would assess the record of monitored activities to determine whether such an event occurred.

In a preferred embodiment, the module 28, upon making the decision in step 62 that immediate care is required, sends control signals to the module 30 to cause the interface 21 to generate audible and visible signals to alert caregivers of the urgency of the situation. In a preferred embodiment, the module 28 causes the system 10 to generate alarms, such as sound or light indications at the interface 21, when there is a variance between what events the schedule requires to be performed and what actually has occurred. For example, sound alarms can be generated at an interface 21 at the nurses station if a patient has remained in a room for too long a period, and this event is identified as a variance with respect to timed activities and expected lengths of stay set forth in a schedule. In a further embodiment, the physician interacts with system 10 at the interface 21 to alter the remainder of the events of the schedule to be performed by the module 28.

Thus, the system 10 detects the variances in real time and, therefore, advantageously alerts caregivers at an interface to take pre-emptive actions that would improve care outcomes or prevent negative outcomes for a particular patient. In addition, the module 28 stores a detailed record of the variances to permit retrospective examination of their causes.

In step 64, the module 28 determines whether the schedule requires that a decision made or an event validated by the module 28 based on specific recorded data must be confirmed using other data. If the schedule requires a confirmation, the module 28 in step 66 transmits a control signal to the display module 30, which in turn causes generation of a confirmation prompt at the interface 21. The prompt requests the caregiver to confirm, for example, the decision by the module 28 that the patient's medical vital signs have improved sufficiently, such that the dosages and types of medication to be provided can be changed to new values. Based on the caregiver's response, which would be limited to a “Yes” or “No”, the module 28 in step 68 determines whether the confirmation was positive. The processor 22 time stamps the confirmation and stores it in memory and, through the module 30, notifies other caregivers on their personal interfaces that the medication order has been changed for the patient.

If the confirmation is positive in step 68, the module 28 in step 70 determines if a detected event was valid. For example, if the module 28 determines that the event of a caregiver performing an EKG had occurred, based on recorded physiological measurement data which the monitoring equipment 20 coupled to the EKG diagnostic equipment transmitted to the controller 12, the module 28 assesses the caregiver and patient location record or proximity information to confirm the event. The event confirmation criteria, for example, require that the recorded data establish that the caregiver and patient were in the same zone during the time when the EKG procedure normally should have been preformed.

If the event is validated in step 70, the module 28 in step 72 updates the status record for the event schedule. For example, the module 28 updates the record of the schedule to indicate that a specific caregiver performed the EKG at a specified time, the results of the EKG and when a caregiver analysis of the EKG results became available for review. Once the module 28 updates the schedule status, the schedule and details on its status are available for display at the interface 21. Further, the module 28 henceforth processes the recorded data in accordance with the updated schedule requirements.

The caregiver thus can access in real time the status of the event schedule for the patient, which has been updated based on an evaluation of events that have occurred and the procedures performed or to be performed. From the available information, the caregiver can determine, for example, the expected and actual time frame for a particular episode of care, the tasks that must be and were performed at different times during that episode of care and the expected and actual outcomes at different stages of the patient's recovery.

In an alternative preferred embodiment, the activity data stored by the system concerning caregiver location patterns can be accessed to permit iterative and quick changes in patient schedules. For example, the electronic care record can indicate that nurses are spending a lot of time off the unit, such as on intrahospital patient transport, which information is valuable for assessing the care processes and resource utilization. At the interface 21, the caregiver, with relative ease, provides instructions to the controller 12 to achieve rapid implementation of a revised schedule, to check the results of the revised schedule and to continue to fine tune the schedule iteratively.

Although preferred embodiments of the present invention have been described and illustrated, it will be apparent to those skilled in the art that various modifications may be made without departing from the principles of the invention.

What is claimed is:

1. A method for electronic monitoring of activities in a tracking environment comprising:
selecting a schedule including a plurality of events;
collecting activity data in substantially real time from the tracking environment;
evaluating the activity data in substantially real time to determine whether at least one of the events of the schedule has been performed;
updating a status record of the schedule in substantially real time based on the evaluation of the activity data; and
making the status record of the schedule and the activity data available for access in real time.

2. The method of claim 1, wherein the evaluating further comprises identifying whether there is a variance with the event schedule.

3. The method of claim 2 further comprising:
generating an alarm signal in substantially real time if a variance is identified.

4. The method of claim 2 further comprising:
modifying the schedule in real time, without human interaction, and using schedule modification criteria included in the schedule, if a variance is identified.

5. The method of claim 2, wherein the activity data includes proximity information concerning first and second energy signal identification badges and wherein the evaluating includes using the proximity information.

6. The method of claim 5, wherein the evaluating includes using the proximity information to identify or confirm the presence of a variance in the schedule.

7. The method of claim 1, wherein the tracking environment is a health care facility and the schedule includes a clinical care pathway.

8. The method of claim 1, wherein the collecting of the activity data is performed passively, automatically and in substantially real time.

9. A system for electronic monitoring of activities in a tracking environment comprising:
a plurality of energy identification badges disposed in the tracking environment for generating identification data signals;
a plurality of sensors disposed in the tracking environment for detecting the identification data signals, converting the detected signals into activity data signals and transmitting the activity data signals, wherein the detecting, converting and transmitting are performed by the sensors in substantially real time; and
a microcontroller for receiving the activity data signals and processing the activity data in accordance with a schedule including a plurality of events, wherein the processing is in real time and comprises:
evaluating the activity data to determine whether at least one of the events of the schedule has been performed;
updating a status record of the schedule based on the evaluation of the activity data; and
making the status record of the schedule and the activity data available for access in real time.

10. The system of claim 9, wherein the evaluating further comprises identifying whether there is a variance with the event schedule.

11. The system of claim 10, wherein the processing further comprises generating an alarm signal if a variance is identified.

12. The system of claim 10, wherein the processing further comprises:
modifying the schedule, without human interaction, and using schedule modification criteria included in the schedule, if a variance is identified.

13. The system of claim 9, wherein the activity data includes proximity information concerning first and second energy signal identification badges and wherein the evaluating includes using the proximity information.

14. The system of claim 9, wherein the evaluating includes using the proximity information to identify or confirm the presence of a variance in the schedule.

15. The system of claim 9, wherein the tracking environment is a health care facility and the schedule includes a clinical care pathway.
